(19) United States
(12) Patent Application Publication
(10) Pub. No.: US 2019/0066012 A1
(43) Pub. Date: Feb. 28, 2019

(54) ENTERPRISE CUSTOMER WEBSITE

(71) Applicant: Beavex Incorporated, Atlanta, GA (US)

(72) Inventors: Travis Abell, Marietta, GA (US); Eric Kierstead, Powder Springs, GA (US)

(21) Appl. No.: 15/880,418

(22) Filed: Jan. 25, 2018

Related U.S. Application Data
(60) Provisional application No. 62/548,608, filed on Aug. 22, 2017.

(51) Int. Cl. G06Q 10/06; H04L 29/06; G06F 17/30

(52) U.S. Cl. CPC G06Q 10/0639; G06F 17/30592; H04L 63/0815; H04L 63/0892

(57) ABSTRACT

A system and method for implementing an Internet website that provides enterprise customers of a service provider access to performance information on a cloud business intelligence application, wherein the performance information is about services rendered by the service provider. The system includes a web server that manages login into a cloud business intelligence software via a customer portal rendered on a webpage, a data warehouse that stores a history of enterprise performance activity, and a computer system that, at incremental times, compresses the data warehouse into reports. The use of reports allows the system and method to deliver requested cloud business intelligence information to a dashboard in a highly responsive manner.

### CROSS-REFERENCE TO RELATED APPLICATIONS

This application claims the benefit of U.S. Provisional Patent Application No. 62/548,608, filed Aug. 22, 2017, the entirety of which is incorporated by reference herein.

### BACKGROUND

Business intelligence reporting systems and services have become an essential part of managing any enterprise. The services collect, aggregate, and process business data from multiple enterprise computer systems, and organize and deliver relevant data to decision makers.

Cloud-based business intelligence solutions have emerged in recent years. Unlike traditional business intelligence services, where the service's platform is hosted on a client enterprise's information system infrastructure, cloud-based business intelligence services reside offsite on information systems hardware maintained by cloud-based service providers. The services are in communication with the client enterprises' information systems and databases via the Internet. Users access the services through business intelligence interfaces called dashboards, such as a dashboard in Microsoft Power BI, provided on client computer devices.

Business intelligence reporting systems that provide user interfaces on public Internet webpages are known in the art. Typically, an interface consists of a dashboard application hosted on a different web domain and embedded on a website such as an enterprise portal. Exemplary embedded dashboard applications include Microsoft's Power BI Embedded. Access to the interface or dashboard via the portal is typically performed with a two-step process: First, Single Sign-On (SSO) protocol is used to log in onto the dashboard application's website. SSO provides a secure way to sign into a software system by shielding from the user the credentials passed to grant access to the third party application (here, the dashboard application). This helps secure the system against unauthorized access and hacking. While implementations of the SSO protocol vary, it generally involves an authentication step, where login credentials are validated, and an authorization step, where access is granted to data associated with the authenticated user account(s). Second, after the dashboard application is securely accessed as described above, the dashboard is embedded into a designated real state on the portal using a web element for framing such as iframe.

This traditional approach to dashboard interfaces presents disadvantages. First, while existing dashboard applications can feature a strong implementation of SSO using token-based authentication, they lack means for selectively authorizing access to accounts associated with authenticated users. This inability to enforce access restrictions for each user presents a problem for cases where the portal is accessible to multiple users. The traditional approach is thus impracticable in organizations that employ a complex account structure where each user has several accounts and user access is limited to subsets of accounts. For example, a large enterprise with several accounts corresponding to distinct geographical territories may only grant its regional managers access to accounts that are germane to their territory.

Another disadvantage of services using the traditional approach is their slow responsiveness. Typically, traditional business intelligence reporting systems rely on large data stores such as data warehouses or data marts to supply data to users. This creates significant challenges for returning data in a timely fashion because backend queries must be performed against a data set that can be as large as several terabytes. As a result, data sets and charts of the interface or dashboard of a cloud-based business intelligence reporting system that relies on a data warehouse may take minutes to refresh—even for minor changes to reporting parameters. This is of particular concern because it only takes the average user approximately six seconds to become impatient with the responsiveness of a system.

### SUMMARY OF THE INVENTION

Embodiments of the present invention disclose a system for implementing an Internet website that provides enterprise customers of a service provider access to performance information on a cloud business intelligence application, wherein the performance information is about services rendered by the service provider. The system includes a web a web server including authentication, authorization, and administration (“AAA”) software that receives login credential, over the Internet, for a plurality of users associated with each of a plurality of enterprise customers of the service provider; cloud business intelligence software that communicates with an external cloud business intelligence application implemented on the Internet and in operation, authenticates and authorizes the web server to login to the cloud business intelligence application; a customer portal that is rendered on a web page of the web server designed to provide enterprise customers access to the performance information and related analytics when appropriate login credentials are received; a data warehouse which stores a history of performance activity for each enterprise customer, wherein a plurality of the enterprise customers have a plurality of accounts with the service provider; and a computer system of the service provider that, at incremental times, applies a set of automated rules to the history of performance activity that converts information in the history to conform to requirements of the cloud business intelligence application including meeting a size limitation, wherein a reduced archive file is generated, and automatically requests the reduced archive file to be processed and produced as a report by the cloud business intelligence application, further wherein, in response to the request, the report is stored on the cloud business intelligence application, wherein the web server provides access to the performance information and related analytics that is based on the reduced archive file in a highly responsive manner by performing authorization and authentication operation for individual login credentials using the AAA software, identifying an association of each particular user with a corresponding enterprise customer and a corresponding subset of accounts of the corresponding enterprise customer that the enterprise customer has specified the particular user to be allowed to view, after the web server is authorized by the cloud business intelligence application, generating and sending a command containing the identified subset of accounts for that particular user when that particular user selects in that customer portal to view the performance information, wherein the command includes a request that the cloud business intelligence application dynamically produce a dashboard specific to the subset of accounts corresponding to that user from the report on the cloud business intelligence application, and implementing a frame in the customer portal that delivers the dashboard for that particular user in the customer portal.

In some embodiments, the reduced archive file includes the entire history of performance activity for each enterprise customer stored in the data warehouse.

In certain embodiments, the set of automated rules applied to the history of performance activity stored in the data warehouse includes converting bit fields of the data warehouse into integers.

In some embodiments, a time between that particular user selecting in that customer portal to view the performance information, and the frame in the customer portal delivering the dashboard for that particular user in the customer portal, is less than five seconds.

Embodiments of the present invention also disclose a method for implementing an Internet website that provides enterprise customers of a service provider access to performance information on a cloud business intelligence application, wherein the performance information is about services rendered by the service provider. The method includes storing in a data warehouse a history of performance activity for each enterprise customer, wherein a plurality of the enterprise customers have a plurality of accounts with the service provider; applying at incremental times using a computer system of the service provider, a set of automated rules to the history of performance activity that converts information in the history to conform to requirements of an external cloud business intelligence application implemented on the Internet including meeting a size limitation, wherein a reduced archive file is generated, and automatically requests the reduced archive file to be processed and produced as a report by the cloud business intelligence application, further wherein, in response to the request, the report is stored on the cloud business intelligence application; receiving over the Internet login credentials for a plurality of users associated with each of a plurality of enterprise customers of the service provider, using authentication, authorization, and administration (“AAA”) software provided on a web server; authenticating and authorizing the web server to login to the cloud business intelligence application using a cloud business intelligence software provided on the web server that communicates with the cloud business intelligence application; and rendering on a web page of the web server a customer portal designed to provide enterprise customers access to the performance information and related analytics when appropriate login credentials are received; wherein the web server provides access to the performance information and related analytics that is based on the reduced archive file in a highly responsive manner by performing authorization and authentication operation for individual login credentials using the AAA software, identifying an association of each particular user with a corresponding enterprise customer and a corresponding subset of accounts of the corresponding enterprise customer that the enterprise customer has specified the particular user to be allowed to view, after the web server is authorized by the cloud business intelligence application, generating and sending a command containing the identified subset of accounts for that particular user when that particular user selects in that customer portal to view the performance information, wherein the command includes a request that the cloud business intelligence application dynamically produce a dashboard specific to the subset of accounts corresponding to that user from the report on the cloud business intelligence application, and implementing a frame in the customer portal that delivers the dashboard for that particular user in the customer portal.

In some embodiments, the reduced archive file includes the entire history of performance activity for each enterprise customer stored in the data warehouse.

In certain embodiments, the set of automated rules applied to the history of performance activity stored in the data warehouse includes converting bit fields of the data warehouse into integers.

In some embodiments, a time between that particular user selecting in that customer portal to view the performance information, and the frame in the customer portal delivering the dashboard for that particular user in the customer portal, is less than five seconds.

Embodiments of the present invention also disclose a method for delivering business intelligence to a website. The method includes receiving from a website rendered on a client computer device, login credentials for a cloud-based business intelligence service maintaining business intelligence data; determining at least one authorized account number based on the received login credentials; transmitting to the cloud-based business intelligence service authorization parameters based on the at least one authorized account number; extracting from the business intelligence service authorized business intelligence data corresponding to the at least one authorized account number; and serving to the client computer rendering the website the authorized business intelligence data.

In some embodiments, the method further includes rendering on the website the authorized business intelligence data, the rendering including providing a frame element on the website and embedding a dashboard on the website using the frame element such that authorized business intelligence data is formatted and displayed on the dashboard embedded on the website.

In certain embodiments, the authorization parameters include an authentication token, a dashboard identification, and the at least one account number. In some of these embodiments, the authorized business intelligence data include an authorized dashboard, the authorized dashboard corresponding to the dashboard identification.

In some embodiments, transmitting to the cloud-based business intelligence service further includes transmitting the authorization parameters to a filter object in the business intelligence service.

In certain embodiments, extracting from the device business intelligence service authorized business intelligence data further includes reading the business intelligence data using a filter object in the business intelligence service, masking from the business intelligence data, data corresponding to account numbers others than the at least one authorized account number using the filter object, and receiving from the filter object authorized business intelligence data corresponding to the at least one authorized account number.

Embodiments of the present invention also disclose an apparatus for delivering business intelligence to a website. The apparatus includes a communication link to the Internet; and a processor and non-volatile memory including a set of computer-readable instructions, wherein the processor is configured to process the computer readable instructions to receive from a website rendered on a client computer device login credentials for a cloud-based business intelligence service maintaining business intelligence data, determine at least one authorized account number based on the received login credentials, transmit to the cloud-based business intelligence service authorization parameters based on the at least one authorized account number, extract from the business intelligence service authorized business intelligence data corresponding to the authorized account numbers, and serve to the client computing device rendering the website the authorized business intelligence data.

In some embodiments, the processor is further configured to process the computer readable instructions to provide a frame element on the website and embed a dashboard on the website using the frame element such that authorized business intelligence data is formatted and displayed on the dashboard embedded on the website.

In certain embodiments, the authorization parameters include an authentication token, a dashboard identification, and the at least one account number. In some of these embodiments, the authorized business intelligence data includes an authorized dashboard, the authorized dashboard corresponding to the dashboard identification.

In some embodiments, the processor is further configured to process the computer readable instructions to transmit the authorization parameters to a filter object in the business intelligence service.

In certain embodiments, the processor is further configured to process the computer readable instructions to read the business intelligence data using a filter object in the business intelligence service; mask from the business intelligence data, data corresponding to non-authorized account numbers using the filter object; and receive from the filter object authorized business intelligence data corresponding to the authorized account numbers.

Embodiments of the present invention also disclose a method for managing authorizations for multiple accounts using a shared authentication token. The method includes receiving from a website login credentials for a remote software service, determining at last one authorized account number corresponding to the received login credentials, transmitting to the remote software service authorization parameters including an authentication token and the at least one account number, extracting from the remote software service authorized data corresponding to the at least one account number, and displaying on the website the authorized data received from the remove software service.

In some embodiments, the method further includes determining a display configuration identifier corresponding to the received logging credentials; transmitting the display configuration identifier to the remote software service; receiving from the remote software service a predetermined display configuration corresponding to the display configuration identifier; and formatting the website using the predetermined display configuration, wherein the formatting includes providing a frame on the website using a frame element, generating an interface inside the frame for the authorized data, and displaying the authorized data within the interface, wherein the interface is generated and the authorized data is displayed according to the predetermined display configuration.

In certain embodiments, transmitting to the remote software service further includes transmitting the authorization parameters to a filter object in the software service, and extracting from the remote software service further includes masking from the filter object data other than the authorized data corresponding to the at least one account number and receiving from the filter object the authorized data.

Embodiments of the present invention also disclose a method for optimizing the delivery of cloud computing data. The method includes generating a compressed cloud dataset including enterprise data for a cloud computing service, the generation including periodically transferring enterprise data from an enterprise database to a data warehouse as warehouse data, compiling the warehouse data as a compressed dataset, and uploading the compressed dataset into the cloud computing service as the compressed cloud dataset; and delivering in response to a query from a client device, enterprise data extracted from the compressed cloud dataset.

In some embodiments, compiling the data warehouse further includes converting bit fields of the warehouse data to integer fields

### BRIEF DESCRIPTION OF THE DRAWINGS

FIG. 1 illustrates a traditional architecture for visualizing corporate data on a public website, in accordance with an embodiment of the present invention.

FIG. 2 illustrates the use of a filter object to pass parameters to a cloud-based business intelligence reporting system, in accordance with an embodiment of the present invention.

FIG. 3 illustrates the traditional approach to enterprise database queries using a cloud-based business intelligence reporting system, in accordance with an embodiment of the present invention.

FIG. 4 illustrates the data warehouse compression process using a report, in accordance with an embodiment of the present invention.

FIG. 5 illustrates the resulting configuration after the data warehouse compression process using a report, in accordance with an embodiment of the present invention.

FIG. 6 illustrates the SSO process into a cloud-based business intelligence reporting service and the data compression process of the data warehouse using reports, in accordance with an embodiment of the present invention.

FIG. 7 illustrates the SSO process into the cloud-based business intelligence reporting service 300 after the compression of the entire data warehouse into a report of the cloud-based business intelligence reporting service, in accordance with an embodiment of the present invention.

### DETAILED DESCRIPTION OF THE PREFERRED EMBODIMENTS

The present system and method will be described in connection with the figures, it being understood that the description and figures are for illustrative, non-limiting purposes.

Embodiments of the present invention disclose a proprietary design and application that provides a highly responsive software interface for a cloud-based business intelligence service that can be accessed with, for example, a single action (e.g., a single mouse click, some short combination of actions, etc.) from a website on the public Internet. The application incorporates a backend design that preferably eliminates traditional database queries regardless of the complexity of the interface. The absence of backend database queries allows dramatic performance improvements over similar current systems. With this design, an exemplary interface is typically refreshed in under 4 seconds, regardless of the complexity of the changes made to the interface. This represents a significant improvement over what is common today among certain cloud-based services.

Embodiments of the present invention specifically address several challenges associated with customer facing, public Internet applications. For example, they incorporate system requirements such as: user authentication, account authorization, security, and the complexities of controlling access to confidential data in a multi-account, multi-tenant environment.

The present solution was thus created to provide a highly responsive, public Internet-facing interface that provides information to the user on accounts stored in the cloud-based service. The present solutions can be used with a number of cloud-based services in a variety of fields. For example, the present solution is particularly suited for use with cloud-based business intelligence reporting systems. In this case, the interface, called a dashboard, which is a commonly understood tool in cloud business intelligence applications can be accessed on an Internet website, and serves to provide several Key Performance Indicators (KPI's) detailing how the company is performing on the user's account.

Based on testing and evaluation, the actual implementation has been found to have the following important capabilities and performance achievements: (1) single action (e.g., 1-click) access to the interface from a pre-existing website on the public Internet; (2) support for a complex underlying account structure, such that users are only granted access to accounts for which they are authorized; (3) a refresh and render time of less than 5 seconds when a user makes a change to the interface that requires a refreshed data set, and (4) function on all mainstream browsers (e.g. Chrome, Edge, Internet Explorer, Firefox).

I. Typical Base Architecture: High Level View

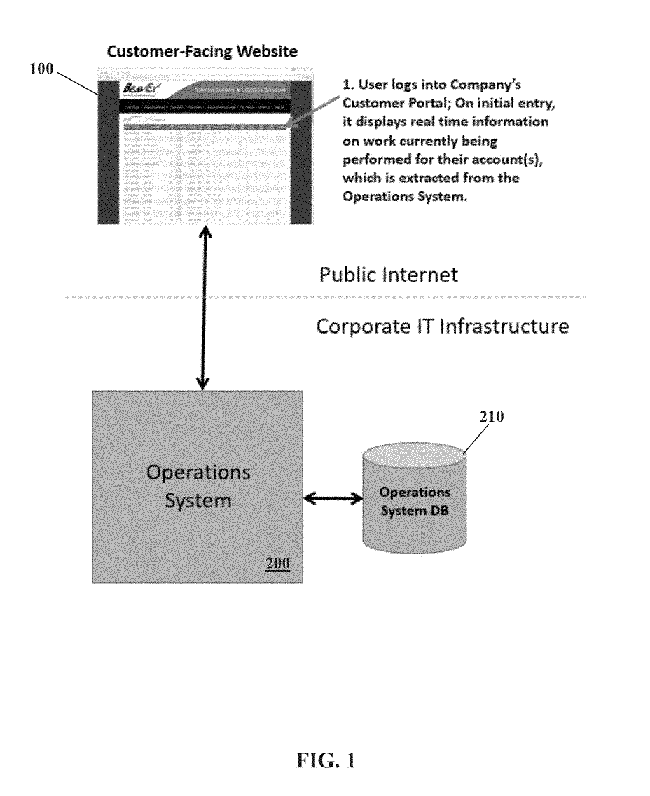

Embodiments of the present invention may be used with websites that are available on the public Internet. A typical implementation might be on a portal website, since portals commonly incorporate other websites into their design. FIG. 1 illustrates a traditional architecture for visualizing corporate data on a public website, in accordance with an embodiment of the present invention. The architecture comprises a customer or enterprise portal 100 on a website displayed on a client computer connected to the public Internet. The website may be hosted by a web server. The web server may be implemented as a computer system in communication with a computer network such as the Internet, and that stores and delivers websites or web pages upon request to client computer devices via the network. The customer portal 100 illustrated in FIG. 1 is a screenshot of an exemplary customer portal 100. The customer portal 100 may requires customers to log in and on initial entry, the portal 100 may display real-time information on work currently being performed for the customer's account(s). The information displayed on the customer portal 100 is provided by an operation's computer system 200 in the corporate IT infrastructure. The system 200 may store and obtain corporate data from an operations system database 210. The customer portal 100 may comprise a link to business intelligence interface or dashboard 110.

II. Single Sign on to the Interface

Embodiments of the present invention may be used with cloud-based business intelligence reporting systems, and in particular, such systems that reside entirely in the business intelligence service provider's cloud infrastructure and have their own web addresses. Interfaces for these systems or services that are hosted on a different web domain can be embedded on websites such as enterprise portals. This is typically accomplished via a two-step process:

1. Single Sign On (SSO) functionality to first log in to the other site, then

2. Embed the site into some designated real estate on the portal via an ‘iframe’ or some other web element.

To ensure SSO is secure, i.e., safe from being hacked by cybercriminals, secure SSO is performed behind the scenes such that the user cannot see the credentials being passed to grant access to the third party application. Techniques vary between applications on how to implement secure SSO.

The SSO process generally involves two steps:

1. Authentication—confirming the login credentials passed are valid, i.e., they match a valid user's credentials

2. Authorization—presenting the correct “authorized” data to the user after logging in. The authorization step often grants access to data associated with an account number or a set of account numbers.

With some cloud-based services however, the SSO process may differ as follows:

1. Authentication—cloud-based services typically have a working structure for logging in using a secure token, aka “token based authentication.”

2. Authorization—some cloud-based services lack a specified procedure (e.g., designated by the application) for passing the needed data, such as account numbers.

The Authorization step (step 2) presents a challenge for any company wishing to use cloud-based services on a public website, where several customers will be accessing the website, needing access to their specific account data. Regarding account numbers, many client companies employ a complex account structure methodology, where each customer may have several accounts. In addition, users' access may be restricted to a subset of their customer accounts. This is common among national companies where customers may have several geographically oriented accounts, and might only grant their regional managers access to accounts that are germane to their geography.

Some cloud-based services offer a “Filter” object functionality. The filter object is used to reduce the set of data being viewed on the interface of the cloud-based service. Typically, the filter object is secure (encrypted) and can hold several data elements. Although the filter object may not be expressly provided by the cloud-based service for passing account numbers, it features that capability. Accordingly, embodiments of the invention use it to transmit account numbers to the cloud-based service. Embodiments of the invention can further extract cloud-based data from the filter object for subsequent use. Specifically, the present system opens the filter object, reads the contents, then masks all other data from the user except data for the passed accounts. This design successfully allows a website to pass any combination of account numbers, or other identifiers, to the cloud-based service for the purpose of filtering the data set and displaying a reduced data set to the user.

a. Passing Parameters via a Filter Object

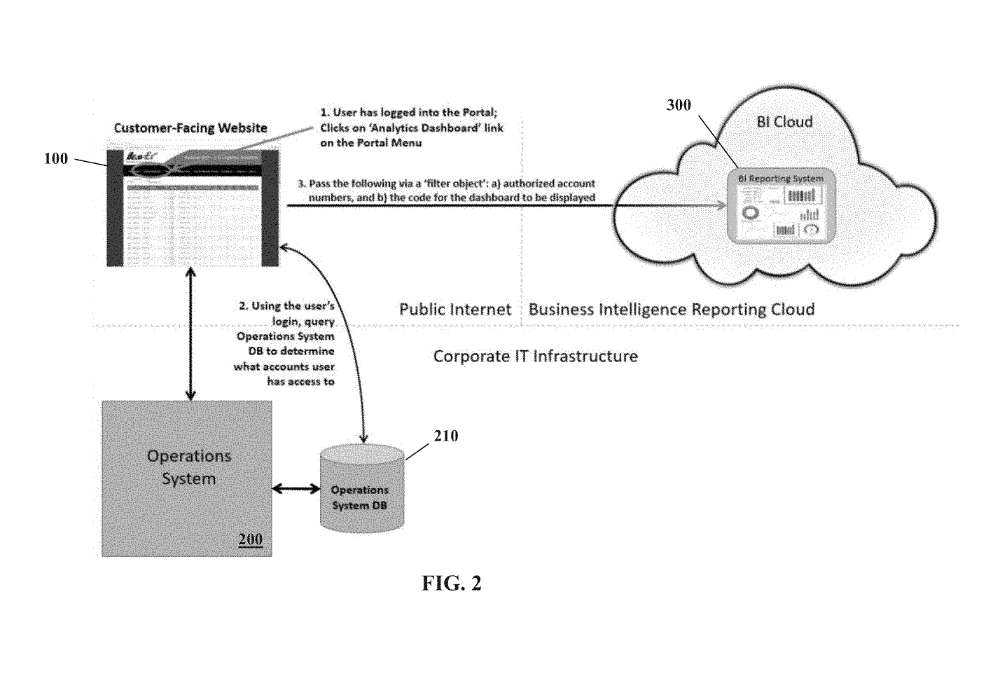

FIG. 2 illustrates the use of a filter object to pass parameters to a cloud-based business intelligence reporting system in accordance with embodiments of the present invention. In particular, FIG. 2 illustrates the interaction between the customer web portal 100, operations system 200 and database 210, and the cloud-based business intelligence reporting system 300. This interaction is further described below:

When a customer on the client company's web portal 100 clicks on a link provided for the business intelligence interface 110, three data elements or authentication parameters are sent to the cloud-based business intelligence reporting system 300:

1. An authentication token for the client company

2. An ID that specifies which interface to display to the particular user

3. An array of account numbers that the user is authorized to view

The data elements transmitted are further explained below:

1. The authentication token is typically created and provided to the client company by the cloud-based business intelligence report service 300 when an account is established with the service 300. Only one token is provided for the entire client company, which must be shared with all employees and customers using the cloud-based interface 110 on the portal 100. This immediately presents the challenge of differentiating between users and specifying to the cloud-based service 300 which accounts particular users are authorized to access.

2. The ID sent is a ‘Globally Unique Identifier” or GUID, which specifies which interface 110 should be displayed to a particular user. Companies can pre-build different interfaces 110 targeted for different aspects or units of their businesses, such as different departments, subsidiaries, or other organizations or entities. In addition, custom interfaces 110 can also be provided to customers with particular reporting needs. When interfaces 110 are initially created and loaded in the cloud-based Business Intelligence Reporting System 300, each is assigned a new GUID and a master list of GUID is kept in a data warehouse. When a user on the website or portal 100 clicks on the link provided for the interface 110, the GUID is used to specify to the cloud-based service 300 which interface 110 to display to that particular user.

3. The array of account numbers collectively represents the set of accounts the given user is allowed to view. In an exemplary system, account numbers have varying lengths and can range from 2 to 8 digits. It is very common for customers to have several accounts with the client company, as many of customers want a unique account number for various distinct purposes such as for each geographical location they serve. Thus the numbers must be passed as an array of variable length, as the list can range from one account number to hundreds.

The following illustrates exemplary values for the data elements or authentication parameters passed to the cloud-based service 300 when a user initiates access from the website 100 by clicking on the link to interface 110:
1. Value for the client company's authentication token (always the same): eyJhbGciOiJIUzI1NiIsInR5cCI6IkpXVCJ9.eyJ2ZXIiOilwLjIuMCIsImF1ZCI6Imh0d HBzOi8vYW5hbHlzaXMud2luZG93cy5uZXQvcG93ZXJiaS9hcGkiLCJpc3MiOiJQb 3dlciBCSSBOb2R1IFNESyIsIndjbiI6IkFuYWx5dGljQ29sbGVjdGlvbiIsIndpZCI6IjY 4OTRmMDQ4LTE2N2EtNGE3NC1hNWMwLTlmM2Y3Y2Y0NDFlZCIsInJpZCI6I jEwM2MwMDRiLWYwZTktNDIzZi1hMDQzLTk1NmZiZGJ1MDQ0YyIsIm5iZiI6 MTQ4NzE2NzE0MywiZXhwIjoxODk2MTM0NDAwfQ.k01XlmvlboVTnLGifKys1 GgLWNuoX1BZXRtygS9JdhU
2. GUID for the client company's customized dashboard: 103c004b-f0e9-423f-a043-956fbdbe044c
3. Array of the client company's IDs: [29,30,202439409,202439411,202439406,202439407,202420291,200582,202605]

III. Making the System Highly Responsive

Arguably the biggest challenge with some cloud-based services, and in particular cloud-based business intelligence reporting systems, is to make them highly responsive, i.e., return results in just a few seconds. It is common for these systems to rely on very large data stores, such as a data warehouses, to supply their data. A data warehouse is a database or set of databases that aggregates and stores historical enterprise performance data based on the operational data of the enterprise. Operational data may be supplied to the data warehouse from other databases in the enterprise operations system. The data warehouse is implemented on a computer system or set of computer systems typically in networked communication with other enterprise computer systems.

The reliance on data warehouses to supply data to cloud-based business intelligence services creates significant challenges for returning data in a timely fashion, since the backend query must be performed against a data set that can be as large as several terabytes. In addition, data warehouses often reside off-site. Exposing any business intelligence reporting system to users on the Internet is therefore challenging, as users are typically willing to wait approximately six seconds before becoming impatient and considering a system too slow. When dealing with large data sets such as data warehouses, business intelligence services may require minutes, not seconds, to have their data sets and charts refreshed when making even a minor change to the reporting parameters.

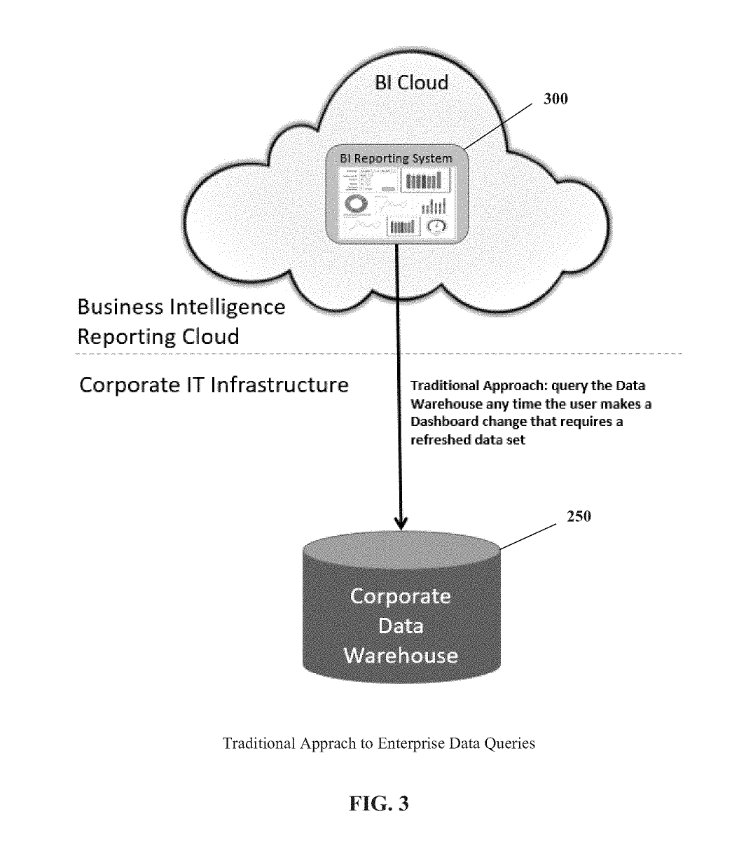

FIG. 3 illustrates the traditional approach to enterprise database queries using cloud-based business intelligence reporting system 300. Traditional models of business intelligence interface 110 have the cloud-based business intelligence reporting systems 300 querying a company's data warehouse 250 to retrieve data for use in the charts of interface 110. However, in some implementations, this approach can take over 60 seconds on average to render the interface 110 to the user, which is unacceptably long.

The improved responsiveness involves the use of compression features provided in the cloud-based service 300. A known feature of cloud business intelligence applications is an aspect referred to as a report 310, such as a report 310 in Microsoft Power BI, which as described herein is used to support parts of the present technical solutions. A report 310 is a nugget of data culled from a larger data set, which is then used to present a targeted set of charts and/or tabular reports to the user. Reports 310 can be held completely in the memory of the cloud-based system 300. However, such memory offers limited capacity, typically under 1 gigabyte. It has been found that the use of reports 310 assists in rendering the cloud-based interface 110 in under 3 seconds. Embodiments of the invention provide a way to use reports 310 to support the disclosed interface 110.

Technical solutions of the problems can include providing a process to periodically and automatically compress the client company's data warehouse 250 (e.g., entire data in the warehouse, substantially all, or a significant portion) into a single report 310 and automatically push the report 310 to the cloud-based Service. A typical frequency for compression and upload into the cloud may be every night. The automatic period compression and upload of data warehouse 250 data has been found to provide these highly desirable advantages:

1. No access to the corporate data warehouse 250 ever required during a user session

2. Interface 110 response times to user input are consistently under 5 seconds.

a. Data Conversion Process

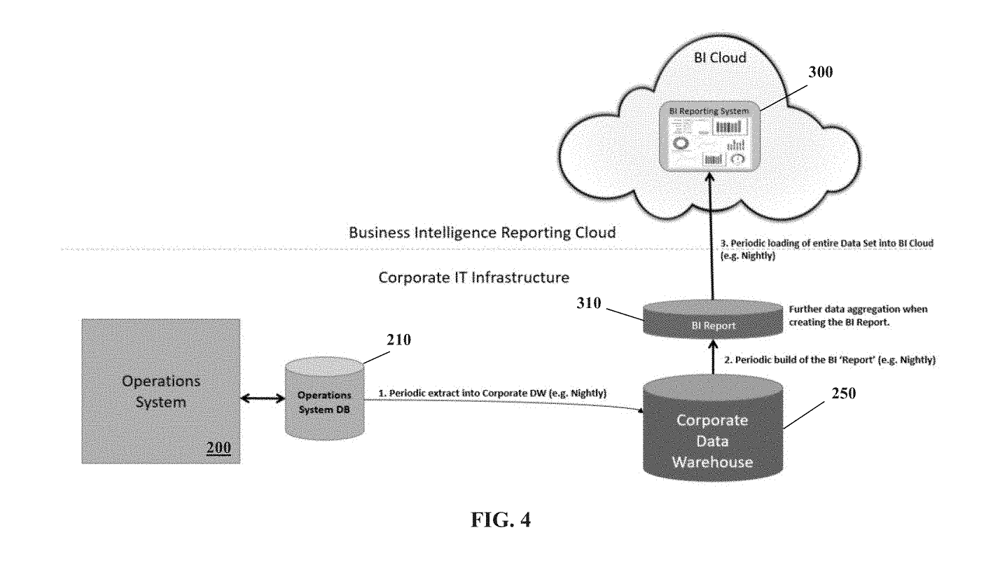

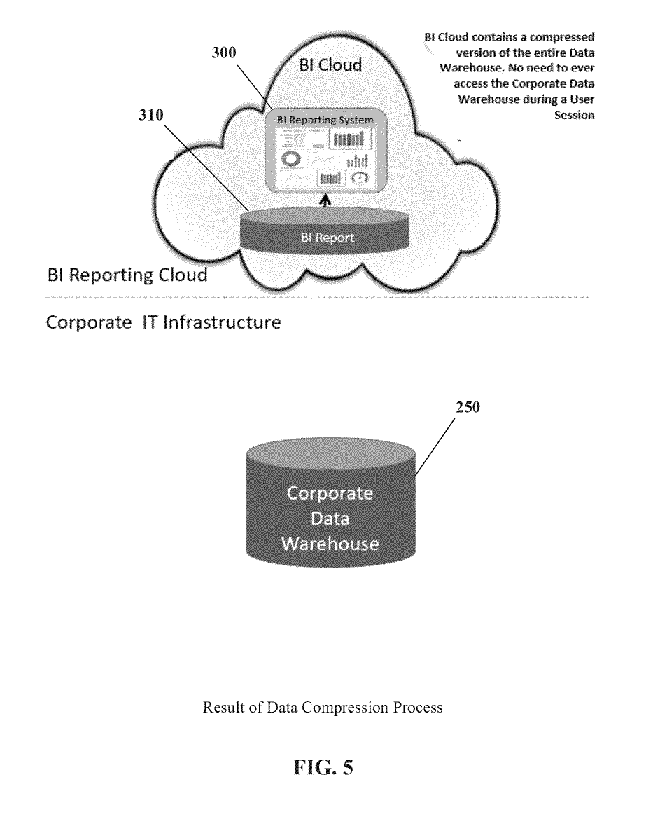

FIG. 4 illustrates the data warehouse compression process report 310, in accordance with embodiments of the present invention. FIG. 5 illustrates the resulting configuration of the data warehouse compression process using report 310, in accordance with embodiments of the present invention. The data warehouse compression process is described below.

A report 310 in accordance with the cloud-based service 300 is used to hold a highly compressed version of an entire data warehouse 250 in the cloud. In some cloud-based business intelligence report services 300, the reports 310 have a maximum size of 1 gigabyte, whereas a data warehouse 250 can be one hundred times larger or more. Accordingly, a report 310 is typically restricted to essential data elements. This reduces the data set by approximately 80%.

To further reduce the data warehouse 250 size, a few techniques can be employed to get the data into smaller data elements. Here are the two most notable examples:

1. Bit to integer conversion: An exemplary on-premise data warehouse 250 may feature several bit (boolean) fields. A bit is typically a very efficient data type; some data warehouses 250, including some types of SQL server-based data warehouses, appear to use as little as a single bit for ‘bit’ fields. However, with certain reports 310 offered by cloud-based services 300, these bits can use considerably more space. Converting bit fields into integers in the cloud-based reports uses approximately 15% less space for those fields.

2. Passing indices (integers) instead of account names—Passing account numbers instead of customer names can reduce data space for compression. In an exemplary case, a data warehouse 250 is set up to identify shipping routes and stops with customer names and account numbers. Instead of associating a customer name with each stop, an indexed list of customer names can be created and each stop can be associated with the identifier for its customer name. This scheme saved an average of 20 bytes per stop record on the exemplary system.

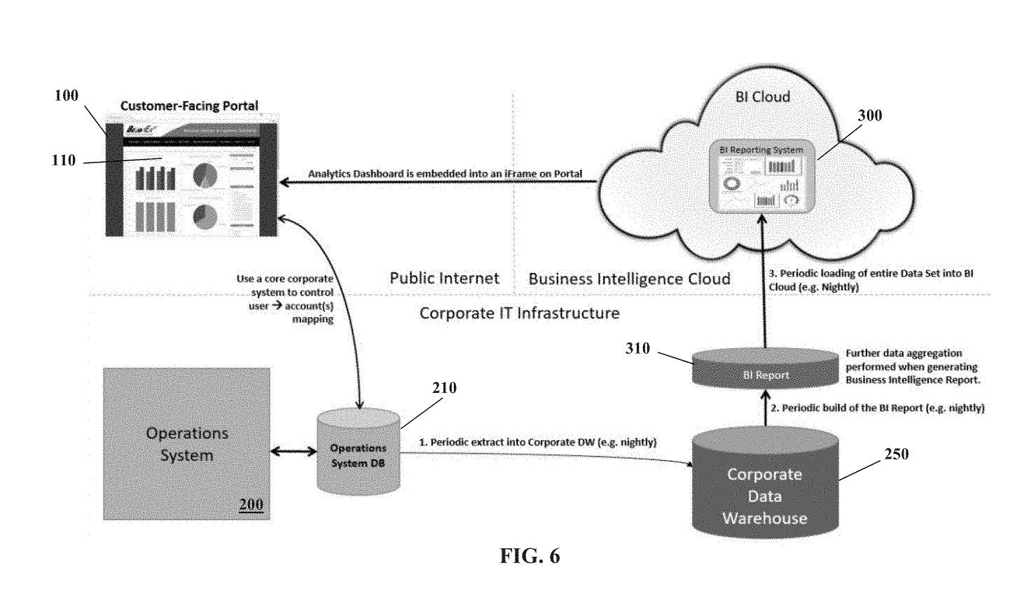

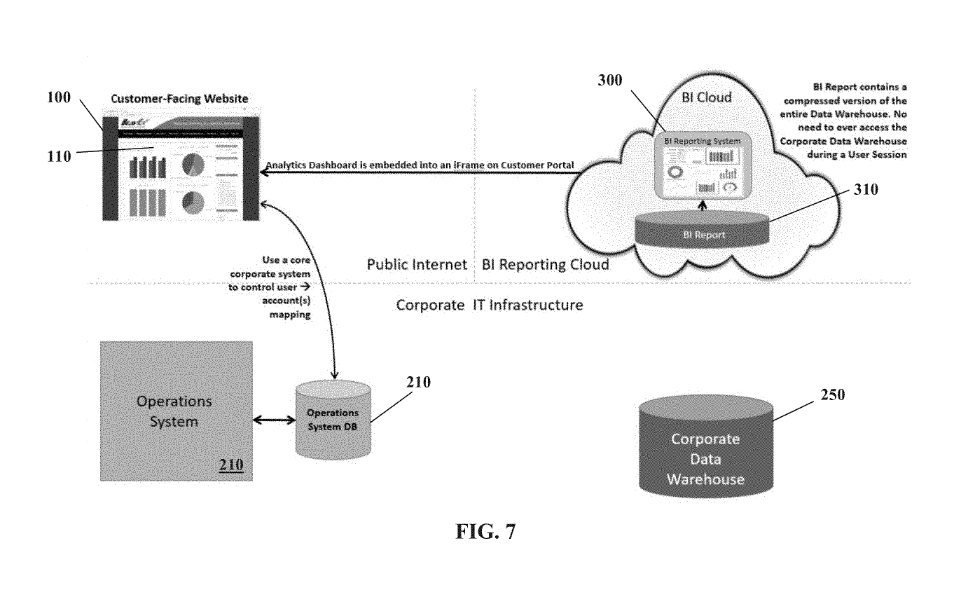

FIG. 6 illustrates the SSO process into a cloud-based business intelligence reporting service 300 and the data compression process of the data warehouse 250 using reports 310, in accordance with an embodiment of the present invention. FIG. 7 illustrates the SSO process into the cloud-based business intelligence reporting service 300 after the compression of the entire data warehouse 250 into a report 310 of the cloud-based business intelligence reporting service 300. The customer portal 100 illustrated in FIGS. 6 and 7 is a screenshot of an exemplary customer portal 100. A business intelligence dashboard 110 is embedded into the portal 100 using an iframe element for example, in accordance with an embodiment of the present invention. The dashboard 110 provides data visualization for business intelligence by illustrating relevant business metrics (e.g., key performance indicators) using visual tools such as graphs and charts (e.g., pie charts). The data visualization of the dashboard 110 is based on data provided using the processes described herein. Combining the SSO process with the data warehouse compression technique achieves the following highly desirable, unique end results:
Fully secure SSO process into a cloud-based service such as a business intelligence reporting service 300, invoked by e.g., a single mouse click on a website 100 in the public Internet
Highly responsive design providing refreshed data to an interface 110 such as refreshed charts on a business intelligence dashboard 110 residing in the public Internet in under 5 seconds.

The present solutions are particularly useful in the field of providing performance information in the field of transportation and logistics services that provided by a service provider to companies. An individual service provider may complete hundreds or thousands of package pickups and deliveries in a single day. This can include many transportation services for each customer and each customer may have many accounts with the service provider (e.g., different regions, different divisions). It is competitively advantageous and desirable by customers to be given access to and be able to analyze the specific performance of services performed for that customer. This so that the customer or individuals responsible for accounts can see certain key characteristics. The value is also in being able to view this information on a historical basis so that the performance of the service provider can be evaluated over a long period or the customer has the option to select different time windows since working with the service provider. This flexibility is provided with quick responsiveness with the present solutions. It can also be configured to provide access to the performance of several service providers (competing providers) so that customers can view information in comparison.

Each of the system, server, computing device, and computer described in this application can be implemented on one or more computer systems and be configured to communicate over a network. They all may also be implemented on one single computer system. For clarity, the terms “computer system”, “computing device”, “computer device”, “computer” and “machine” are understood to be interchangeable terms and shall be taken to include any collection of computing devices that individually or jointly execute a set (or multiple sets) of instructions to perform any one or more of the methods discussed herein.

A computer system as described herein may include a bus or other communication mechanism for communicating information, and a hardware processor coupled with bus for processing information.

The computer system may also include a main memory, such as a random access memory (RAM) or other dynamic storage device, coupled to bus for storing information and instructions to be executed by processor. Main memory also may be used for storing temporary variables or other intermediate information during execution of instructions to be executed by processor. Such instructions, when stored in non-transitory storage media accessible to processor, render computer system into a special-purpose machine that is customized to perform the operations specified in the instructions.

The computer system may further include a read only memory (ROM) or other static storage device coupled to bus for storing static information and instructions for processor. A storage device, such as a magnetic disk or optical disk, may be provided and coupled to bus for storing information and instructions.

The computer system may be coupled via bus to a display, such as a cathode ray tube (CRT), for displaying information to a computer user. An input device, including alphanumeric and other keys, may be coupled to bus for communicating information and command selections to processor. Another type of user input device is cursor control, such as a mouse, a trackball, or cursor direction keys for communicating direction information and command selections to processor and for controlling cursor movement on display. This input device typically has two degrees of freedom in two axes, a first axis (e.g., x) and a second axis (e.g., y), that allows the device to specify positions in a plane.

The computer system may implement the techniques described herein using customized hard-wired logic, one or more ASICs or FPGAs, firmware and/or program logic which in combination with the computer system causes or programs computer system to be a special-purpose machine. According to one embodiment, the techniques herein are performed by the computer system in response to the processor executing one or more sequences of one or more instructions contained in main memory. Such instructions may be read into main memory from another storage medium, such as storage device. Execution of the sequences of instructions contained in main memory causes the processor to perform the process steps described herein. In alternative embodiments, hard-wired circuitry may be used in place of or in combination with software instructions.

The term storage media as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device. Volatile media includes dynamic memory, such as main memory. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus. Transmission media can also take the form of acoustic or light waves, such as those generated during radio-wave and infra-red data communications.

Various forms of media may be involved in carrying one or more sequences of one or more instructions to the processor for execution. For example, the instructions may initially be carried on a magnetic disk or solid state drive of a remote computer. The remote computer can load the instructions into its dynamic memory and send the instructions over a telephone line using a modem. A modem local to the computer system can receive the data on the telephone line and use an infra-red transmitter to convert the data to an infra-red signal. An infra-red detector can receive the data carried in the infra-red signal and appropriate circuitry can place the data on bus. Bus carries the data to main memory, from which processor retrieves and executes the instructions. The instructions received by main memory may optionally be stored on storage device either before or after execution by the processor.

The computer system may also include a communication interface coupled to bus. The communication interface provides a two-way data communication coupling to a network link that is connected to a local network. For example, the communication interface may be an integrated services digital network (ISDN) card, cable modem, satellite modem, or a modem to provide a data communication connection to a corresponding type of telephone line. As another example, the communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

Network link typically provides data communication through one or more networks to other data devices. For instance, network link may provide a connection through local network to a host computer or to data equipment operated by an Internet Service Provider (ISP). ISP in turn provides data communication services through the worldwide packet data communication network now commonly referred to as the “Internet.” Local network and Internet both use electrical, electromagnetic or optical signals that carry digital data streams. The signals through the various networks and the signals on network link and through the communication interface, which carry the digital data to and from the computer system, are example forms of transmission media.

The computer system can send messages and receive data, including program code, through the network(s), network link and the communication interface. In the Internet example, a server might transmit a requested code for an application program through Internet, ISP, local network and the communication interface.

The received code may be executed by the processor as it is received, and/or stored in storage device, or other non-volatile storage for later execution.

It should be understood that variations, clarifications, or modifications are contemplated. Applications of the technology to other fields are also contemplated. Exemplary systems, devices, components, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

Thus, for example, any sequence(s) and/or temporal order of steps of various processes or methods that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It is also implicit and understood that the applications or systems illustratively described herein provide computer-implemented functionality that automatically performs a process or process steps unless the description explicitly describes user intervention or manual operation.

It is understood from the above description that the functionality and features of the systems, devices, components, or methods of embodiments of the present invention include generating and sending signals to accomplish the actions.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention

It should be understood that combinations of described features or steps are contemplated even if they are not described directly together or not in the same context. The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that for example may involve multiple possibilities, but to a person of ordinary skill in the art a reasonable or primary understanding or meaning is understood.

It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A system for implementing an Internet website that provides enterprise customers of a service provider access to performance information on a cloud business intelligence application, wherein the performance information is about services rendered by the service provider, comprising:
a web server comprising authentication, authorization, and administration (“AAA”) software that receives login credential, over the Internet, for a plurality of users associated with each of a plurality of enterprise customers of the service provider; cloud business intelligence software that communicates with an external cloud business intelligence application implemented on the Internet and in operation, authenticates and authorizes the web server to login to the cloud business intelligence application; a customer portal that is rendered on a web page of the web server designed to provide enterprise customers access to the performance information and related analytics when appropriate login credentials are received;
a data warehouse which stores a history of performance activity for each enterprise customer, wherein a plurality of the enterprise customers have a plurality of accounts with the service provider; and
a computer system of the service provider that, at incremental times, applies a set of automated rules to the history of performance activity that converts information in the history to conform to requirements of the cloud business intelligence application including meeting a size limitation, wherein a reduced archive file is generated, and automatically requests the reduced archive file to be processed and produced as a report by the cloud business intelligence application, further wherein, in response to the request, the report is stored on the cloud business intelligence application,
wherein the web server provides access to the performance information and related analytics that is based on the reduced archive file in a highly responsive manner by performing authorization and authentication operation for individual login credentials using the AAA software, identifying an association of each particular user with a corresponding enterprise customer and a corresponding subset of accounts of the corresponding enterprise customer that the enterprise customer has specified the particular user to be allowed to view, after the web server is authorized by the cloud business intelligence application, generating and sending a command containing the identified subset of accounts for that particular user when that particular user selects in that customer portal to view the performance information, wherein the command includes a request that the cloud business intelligence application dynamically produce a dashboard specific to the subset of accounts corresponding to that user from the report on the cloud business intelligence application, and implementing a frame in the customer portal that delivers the dashboard for that particular user in the customer portal.

2. The system of claim 1, wherein the reduced archive file comprises the entire history of performance activity for each enterprise customer stored in the data warehouse.

3. The system of claim 1, wherein the set of automated rules applied to the history of performance activity stored in the data warehouse comprises converting bit fields of the data warehouse into integers.

4. The system of claim 1, wherein a time between that particular user selecting in that customer portal to view the performance information, and the frame in the customer portal delivering the dashboard for that particular user in the customer portal, is less than five seconds.

5. A method for implementing an Internet website that provides enterprise customers of a service provider access to performance information on a cloud business intelligence application, wherein the performance information is about services rendered by the service provider, comprising:
storing in a data warehouse a history of performance activity for each enterprise customer, wherein a plurality of the enterprise customers have a plurality of accounts with the service provider;
applying at incremental times using a computer system of the service provider, a set of automated rules to the history of performance activity that converts information in the history to conform to requirements of an external cloud business intelligence application implemented on the Internet including meeting a size limitation, wherein a reduced archive file is generated, and automatically requests the reduced archive file to be processed and produced as a report by the cloud business intelligence application, further wherein, in response to the request, the report is stored on the cloud business intelligence application;
receiving over the Internet login credentials for a plurality of users associated with each of a plurality of enterprise customers of the service provider, using authentication, authorization, and administration (“AAA”) software provided on a web server;
authenticating and authorizing the web server to login to the cloud business intelligence application using a cloud business intelligence software provided on the web server that communicates with the cloud business intelligence application; and
rendering on a web page of the web server a customer portal designed to provide enterprise customers access to the performance information and related analytics when appropriate login credentials are received,
wherein the web server provides access to the performance information and related analytics that is based on the reduced archive file in a highly responsive manner by performing authorization and authentication operation for individual login credentials using the AAA software, identifying an association of each particular user with a corresponding enterprise customer and a corresponding subset of accounts of the corresponding enterprise customer that the enterprise customer has specified the particular user to be allowed to view, after the web server is authorized by the cloud business intelligence application, generating and sending a command containing the identified subset of accounts for that particular user when that particular user selects in that customer portal to view the performance information, wherein the command includes a request that the cloud business intelligence application dynamically produce a dashboard specific to the subset of accounts corresponding to that user from the report on the cloud business intelligence application, and implementing a frame in the customer portal that delivers the dashboard for that particular user in the customer portal.

6. The method of claim 5, wherein the reduced archive file comprises the entire history of performance activity for each enterprise customer stored in the data warehouse.

7. The method of claim 5, wherein the set of automated rules applied to the history of performance activity stored in the data warehouse comprises converting bit fields of the data warehouse into integers.

8. The method of claim 5, wherein a time between that particular user selecting in that customer portal to view the performance information, and the frame in the customer portal delivering the dashboard for that particular user in the customer portal, is less than five seconds.
